(19) United States
(12) Patent Application Publication
(10) Pub. No.: US 2003/0220035 A1
(43) Pub. Date: Nov. 27, 2003

(54) Reinforced unsaturated polyester resin compositions

(76) Inventor: Douglas E. Fjare, Naperville, IL (US)

Correspondence Address: CAROL WILSON, BP AMERICA INC., MAIL CODE 5 EAST, 4101 WINFIELD ROAD, WARRENVILLE, IL, 60555, US

(21) Appl. No.: 10/151,746

(22) Filed: May 17, 2002

(51) Int. Cl. B32B 5/02; B32B 27/04; B32B 27/12

(52) U.S. Cl. 442/103; 428/297.4; 428/301.4; 442/172; 442/178; 442/179; 525/242

(57) ABSTRACT

Unsaturated polyester compositions modified with a polyisocyanate provide low cost thermosetting matrix resins with improve adhesion to carbon fibers. The modified polyester resins are useful in fabricating low cost carbon fiber-reinforced composites.

This invention relates to fiber-reinforced thermosetting resin compositions, and more particularly to carbon fiber-reinforced composites comprising an unsaturated polyester resin matrix. Still more particularly, the matrix resin component of the invented composites comprises an unsaturated phthalate polyester and an organic diisocyanate dissolved or dispersed in a reactive solvent. Novel matrix resin formulations comprising isophorone diisocyanate-doped unsaturated isophthalate polyester in styrene monomer are particularly preferred.

Composites comprising carbon fiber and the invented matrix resin formulations demonstrate excellent physical properties and retention of strength and hardness in corrosive environments.

### BACKGROUND OF THE INVENTION

Fiber-reinforced plastic (FRP) composites are high strength, high modulus materials used in a wide variety of aircraft, automotive, and sporting goods applications. For example, glass fiber-reinforced composites and laminates have long been used in the manufacture of boat hulls, automobile bodies and the like. Because of their light weight, high modulus and great strength, advanced composites comprising carbon fiber-reinforced plastic (CFRP) find wide acceptance in the manufacture of a variety of aircraft components, including skin panels, fairings, floor panels and the like. CFRP shafts are lighter in weight than conventional steel club shafts and provide golf clubs which can hit a golf ball longer distances. The combination of light weight and high modulus of CFRP composites has also led to the development of improved weight reduction strategies useful in the manufacture of automotive components as well as a wide variety of medical equipment including wheel chairs and prostheses and sporting goods such as bicycles, skis, tennis rackets, and the like.

Typically, such composites comprise structural fibers embedded in a thermosetting resin matrix. The mechanical properties of such composites, particularly including tensile strength, modulus, and compressive strength, depend on both the matrix resin and the reinforcing fiber. The resin matrix affects all of these properties, but it has the greatest effect on compressive strength and transverse tensile properties. Factors that govern the fiber's contribution, in addition to the amount of fiber in the composite, include the basic mechanical properties of the fiber itself and the surface interaction between fiber and resin. The level of reinforcement supplied by the fiber will be affected by the adhesion between the fiber and the matrix resin. Good adhesion is necessary for any resin system to ensure that the loads are transferred efficiently and to prevent cracking or fiber/resin debonding when stressed.

Epoxies are well known and widely employed as matrix resins. The ability of epoxies to adhere well to most fibers, as well as their inherent toughness, has led to their acceptance as the matrix component of glass-fiber-reinforced plastics used in a wide variety of applications. State-of-the-art epoxy resin formulations are used in the manufacture of CFRP composites with high compressive strengths, good fatigue characteristics, and low shrinkage during cure. However, epoxy resins generally are the most expensive of the matrix resins employed in the manufacture of composites. Because of their high cost, high performance composites comprising high modulus, high tensile strength carbon fibers and epoxy matrix resins have found only limited acceptance outside of the aerospace and aircraft industries. As the price of carbon fiber decreases, there is an incentive to use less expensive resins as the matrix component of CFRP materials to provide lower cost CFRP composites suitable for use as replacements for glass fiber-reinforced materials in applications where strength and weight are important factors.

Glass fiber-reinforced composites comprising vinyl ester resins as the matrix resin component are also well known. Vinylester resins show good fiber adhesion only to glass fiber; adhesion to carbon fiber and more exotic fibers such Kevlar and to wood is generally poor. Tough vinylester matrix resins suitable for the production of advanced composites also are quite expensive; the costs associated with their use approaches that of epoxies.

The least expensive resins available to the FRP industry are polyester resins. Polyester resins are conveniently produced by dissolving an unsaturated, generally linear polyester in an inexpensive vinyl-type active monomer such as, for example, styrene, methyl styrene, diallyl phthalate or the like. Cure is effected using peroxide catalysts together with suitable promoters, or heat. Glass fiber-reinforced composites comprising polyester resins are well known and widely used in a variety of commercial applications including boat hulls and the like. Polyester resins generally available to the art are only compatible with glass fibers, and are best suited for applications insensitive to weight that do not require high adhesion or fracture toughness. Composites comprising polyester matrix resins are prone to micro-cracking and secondary bond failures.

Sheet molding compounds (SMC) and bulk molding compounds are moldable thermosetting materials comprising a staple glass fiber, for example, chopped glass fiber or fiber mat, embedded in a matrix resin. A modified polyester resin suitable as the matrix resin component for these uses may contain one or more of a variety of thickenening agents to provide a curable flexible material in sheet form that is handleable and can be slit, cut, rolled, or formed and compression molded. Impregnating glass fiber with an unsaturated polyester resin matrix thickened by adding a polyisocyanate in substantially stoichiometric amounts with respect to the hydroxyl content of the polyester is disclosed in U.S. Pat. No. 4,327,145. Reaction of the isocyanate with the polyester provides a tack-free, flexible B-staged sheet molding compound, or prepreg. The SMC is shaped and then thermoset in a subsequent compression molding operation. Sheet molding compounds comprising such isocyanate-modified polyesters in combination with carbon fiber and glass fiber, or with carbon fiber alone, are also known.

Methods for producing fiber-reinforced plastics from continuous fiber in the form of tow, tape, woven fabric or the like coated with a curable matrix resin are also well known and widely used commercially. Such processes may include coating and fabricating the fiber in a continuous operation such as, for example, filament winding, and may further include continuous thermosetting of the fabricated material as it is formed, as in pultrusion operations. Processes for continuously coating or impregnating fiber strand at a high rate require liquid resins, or resin solutions, having a low viscosity at ambient temperatures to ensure thorough penetration of the fiber bundle without curing or thermosetting the resin. Thus, the thickened matrix resins employed for the production of SMC and bulk molding resins are generally not well suited for such processes.

The development of a low cost coating resin with good adhesion to carbon fiber suitable for use in the production of carbon fiber-reinforced composites would thus be an important advance in the composite arts. A low cost matrix resin that, when combined with carbon fiber and cured, exhibits good strength properties at elevated temperatures and retention of strength and hardness in corrosive environments would be particularly desirable.

### SUMMARY OF THE INVENTION

The invention is directed to modified polyester matrix resin compositions with good adhesion to carbon fiber suitable for use in providing low cost carbon fiber-reinforced composites. The modified polyester resins useful in the practice of the invention comprise an unsaturated polyester dissolved or dispersed in a liquid copolymerizable monomer together with an organic diisocyanate, preferably an aliphatic diisocyanate. Matrix resin formulations comprising isophorone diisocyanate and an unsaturated isophthalate polyester in styrene monomer are particularly preferred.

Composites comprising carbon fiber and the invented matrix resin formulations demonstrate excellent physical properties and retention of strength and hardness in corrosive environments.

Improved carbon fiber-reinforced composites comprising such matrix resins may be particularly useful in providing low cost structural components in a wide variety of applications, and may find acceptance as a replacement for glass fiber-reinforced composite materials in applications where weight is an important consideration.

### DETAILED DESCRIPTION OF THE INVENTION

The modified polyester matrix resin comprises an unsaturated polyester, a copolymerizable unsaturated monomer, and an organic polyisocyanate.

Unsaturated polyesters useful in the practice of the invention may be generally described as oligomers obtained by the polyesterification of at least one unsaturated dicarboxylic acid or anhydride with at least one polyhydric alcohol, and, preferably, at least one saturated or aromatic polycarboxylic acid or anhydride. Typical unsaturated dicarboxylic acids include maleic acid, fumaric acid, citaconic acid, chloromaleic acid, allyl succinic acid, itaconic acid, mesaconic acid, their anhydrides and mixtures thereof, with maleic anhydride being the preferred choice. Examples of polyhydric alcohols which are useful in the invention include neopentyl glycol, ethylene glycol, diethylene glycol, triethylene glycol, propylene glycol, dipropylene glycol, 1,4-butanediol, polyethylene glycol, mannitol, 1,2-propanediol, 1,6-hexanediol, 1,3-butylene glycol and mixtures thereof, with propylene glycol being preferred. Propylene glycol offers good physical properties at low cost. Better weathering and improved resistance to alkaline chemicals can be achieved by using neopentyl glycol.

Typical polycarboxylic acids include aromatic dicarboxylic acids such as isophthalic acid, orthophthalic acid, terephthalic acid and the like, and aliphatic dicarboxylic acids such as succinic acid, adipic acid, chlorendic anhydride and the like, and mixtures thereof, with isophthalic acid being the preferred choice.

Typical molecular weights of unsaturated polyesters (on a solid basis) useful in the invention are between about 1000 and about 2500 g/mole. Generally, the polyester will have an acid number in the range of from about 5 to about 25 mg KOH/g of resin. The resin hydroxyl number will depend upon the resin acid number and the stoichiometric ratio of glycol/acid. Preferably, the hydroxyl number will lie in the range of from about 30 to about 120 mg KOH/g of resin.

The polyesters typically are dissolved in about 20 to about 60 wt. % of a liquid ethylenically unsaturated monomer copolymerizable with the unsaturated polyester to form a polyester resin composition. Monomers that may be useful for these purposes include vinyl aromatic monomers such as, for example, styrene, vinyl toluene, t-butylstyrene, chlorostyrene, divinylbenzene, α-methylstyrene, and acrylic monomers such as diacetone-acrylamide, hydroxyethyl acrylate, hydroxypropyl acrylate, hydroxypropyl methacrylate, methyl methacrylate, butyl methacrylate, and butyl acrylate. Preferably, the monomer will be a vinylaromatic monomer, more preferably styrene or vinyl toluene. Styrene will be preferred for most applications because it provides an economical monomer solution, is a good solvent for unsaturated resins and enables low viscosity at lower monomer levels.

The amount of the monomer in the resin composition will depend upon a variety of factors including the particular monomer selected, the molecular weight of the polyester, and the desired application viscosity of the resin. Generally, the amount will lie in a range of from 25 to 55 percent by weight of the combined weight of polyester and monomer. Preferably, the resin composition will comprise unsaturated polyesters based on isophthalic acid, maleic anhydride and propylene glycol dissolved in from about 30 to about 50 wt. % styrene. Generally the solution will also contain a polymerization inhibitor.

A wide variety of polyester resin compositions suitable for the purposes of this invention, including the preferred isopolyester resins, are readily available from commercial sources. Commercial resins may be tailored for a particular use or fabricating operation, for example in pultrusion, filament winding, compression molding and the like, and may be further formulated for use in coating operations and in impregnating a variety of fabric reinforcement, woven and non-woven mat structures and the like. Methods for the manufacture of unsaturated polyester resins are also well known and widely employed commercially. For example, isophthalic resins are manufactured by two-stage processing to facilitate the dissolution of the isophthalic acid. In the first stage, the glycol and isophthalic acid react at elevated temperatures, typically about 210° C., under an inert atmosphere to produce a clear melt. High pressure processing, typically 207 kPa (30 psi), and esterification catalysts such as hydrated monobutyl tin oxide are also widely employed to reduce the cycle times of two-stage processing. Maleic anhydride is added in the second stage and the final resin is completed at a temperature of about 240° C. to control color and molecular weight development. Isophthalic resins intended for corrosion applications are processed to the highest molecular weight that can meet the desired viscosity requirement at a given styrene content. The typical reaction cycle is about 24 hours.

In commercial operations the polyesterification will normally be carried out in stainless steel vessels ranging from 8,000 to 20,000 liters, heated and cooled through internal coils. Blade agitators revolving at from 70 to 200 rpm are effective in stirring the low viscosity mobile reactants, which are maintained under an inert atmosphere of nitrogen or carbon dioxide during the reaction at temperatures up to 240° C.

The organic polyisocyanate component of the modified polyester resin will preferably be a diisocyanate, and may be any of the wide variety of diisocyanates available to the resin arts and widely used in the production of urethane resins. Typical diisocyanates suitable for use with unsaturated polyesters include aliphatic diisocyanates such as, for example, isophorone diisocyanate (IPDI), hexamethylene diisocyanate (HMDI) and the like, and aromatic diisocyanates including methylene diphenyl diisocyanate (MDI), toluene diisocyanate (TDI), and the like. Polyisocyanates such as Isonate 143L (an oligomeric MDI from Dow Chemical) may also be useful.

Aliphatic diisocyanates will be preferred, and isophorone diisocyanate will be most preferred. Aliphatic diisocyanates generally react with the polyester component more slowly, and resin formulations comprising aliphatic diisocyanates will generally have a longer pot life. IPDI has both a primary (fast reacting) isocyanate group and a secondary (slower to react) isocyanate group. The IPDI thus can attach quickly to the polyester through reaction of the primary isocyanate group with the hydroxyl functionality of the polyester. Crosslinking and gel formation, which occurs through reaction of the secondary isocyanate group with the polyester, proceeds slowly until heat is generated by the curing process, giving the matrix resin a latent reactivity. The latent cure of the second isocyanate group appears to provide means for bonding the matrix resin to the carbon fiber surface.

The amount of diisocyanate employed will depend upon the reactive hydroxyl content of the unsaturated polyester resin component. Generally, the composition will comprise from about 5 to about 65 mole %, preferably from about 35 to about 50 mole %, of the amount of diisocyanate needed to react with all of the reactive hydroxyl groups in the polyester. That is, the composition will comprise an amount of diisocyanate sufficient to provide a ratio of isocyanate groups to reactive hydroxyl groups of from about 0.05:1 to about 0.65:1, preferably from about 0.35:1 to about 0.50:1. Thus, a composition comprising an unsaturated polyester having a hydroxyl number of 100 mg KOH/g, corresponding to 1.8 meq of hydroxyl groups per gram of resin, would require from 0.09 to about 1.28 meq of the organic diisocyanate.

The composition may further include conventional polymerization catalysts such as, for example, benzoyl peroxide, methyl ethyl ketone peroxide, lauroyl peroxide, cumene hydroperoxide, dicumyl peroxide, t-butyl perbenzoate, or the like, to catalyze the copolymerization of the unsaturated polyester resin and monomer. Small amounts of organic cobalt initiators such as cobalt naphthenate, cobalt octoate or the like are also preferably added to facilitate the catalyst breakdown. The amount of catalyst, as well as the particular catalyst selected, will depend in part upon the intended end use and the particular unsaturated polyester composition. For example, obtaining a gel time appropriate for hand lay-up fabrication at a particular temperature may require a low level of peroxide, while higher amounts will be employed when rapid cures are desired. Selection of the catalyst and determination of the particular amounts is well known and understood by those skilled in the resin arts.

Generally, the diisocyanate and the polymerization catalyst components will be added to the polyester composition just prior to the fabrication operation. The diisocyanate will preferably be added prior to adding the polymerization catalyst.

Optionally, the modified polyester resins of this invention may further include additional additives such as fillers, viscosity modifiers, thickeners, pigments, mold release agents, water scavengers, internal lubricants, low profile additives and other processing aids, all of which are well known to those skilled in the art.

The modified polyester resin of this invention will have improved adhesion to carbon fiber, and thus may be found particularly useful as the matrix component of carbon fiber-reinforced plastic composites. By the term carbon fiber is meant any of the conventional carbonized or graphitized fiber obtained by known processes from such organic fiber or filament precursors as rayon, polyacrylonitrile, pitch or the like. Carbon fiber suitable for use in the practice of this invention is readily available from many commercial sources in a wide variety of forms. For example, fiber supplied in continuous form as tow, tape, roving, yarn or the like may be used with the invented matrix resin in forming unidirectionally reinforced composites, pultrusions and the like. Alternatively, fiber in the form of non-woven, melt-spun fiber mat or fabric may be impregnated with the invented modified polyester matrix resin to form prepreg for use in a variety of fabrication processes. Chopped or milled carbon fiber may also be used as a filler.

The invention described herein will be better understood by consideration of the following examples, which are offered by way of illustration.

### EXAMPLES

Components used in preparing the formulations of the following examples and their abbreviated designations include:

PG: polypropylene glycol

IPA: isophthalic acid

DEG: diethylene glycol

MA: maleic anhydride

CoOct: cobalt octoate

STY: styrene

MEKP: methyl ethyl ketone peroxide

PA: phthalic anhydride

TPA: terephthalic acid

CF-1: 48K tow PAN-based carbon fiber obtained from Zoltek

CF-2: 12K tow carbon fiber, obtained as Thornel T-300 carbon fiber from BP Amoco Corporation

CF-3: 12K carbon fiber tow obtained as Thornel T300, sized with UC-309 sizing, from BP Amoco Corporation.

CF-4: 12K carbon fiber tow obtained as AS-4 grade carbon fiber sized with GP resin sizing, from Hexcel Fibers

CF-5: 48K carbon fiber tow obtained as Panex 33 grade carbon fiber sized with 131 resin sizing, from Zoltek

CF-6: 48K carbon fiber tow obtained as Panex 33 grade carbon fiber sized with XII resin sizing, from Zoltek

IPDI: Isophorone diisocyanate, obtained from Aldrich Chemical Company

HMDI: Hexamethylene diisocyanate, obtained from Aldrich Chemical Company

MDI: methylene diphenyl diisocyanate, obtained from Aldrich Chemical Company

TDI: toluene diisocyanate, obtained from Aldrich Chemical Company

Isonate: an oligomeric MDI diisocyanate, obtained as Isonate 143L from Dow Chemical Company.

Testing Methods

Short beam shear strength (Shear Str) was measured in accordance with ASTM-D2344, using a span to depth ratio of 4:1 and a crosshead speed of 0.05 inch per minute. Short beam shear strength of a composite is a measure of fiber-matrix adhesion.

Flexural strength (Flex Str) and flexural modulus (Flex Mod) were determined following the procedures of ASTM-D790, using a span to depth ratio of 32:1 and a crosshead speed of 0.11 inch per minute. The reported results are normalized to 60 vol % carbon fiber.

Resin acid number, reported in mg KOH/gm of resin, was determined by titration with 0.1 N KOH.

Resin hydroxyl number was calculated from the final acid number and the stoichiometric ratio of glycol/acid employed.

Polyester Resins

Unsaturated polyester compositions were prepared by a two-stage method, and then diluted with styrene. The following preparation of an isopolyester with a 1:2 mole ratio of isophthalic acid to maleic anhydride will serve to illustrate the process.

A four-liter glass resin reactor fitted with a mechanical stirrer, a steam-jacketed distillation column, a water-cooled condenser and a nitrogen sparger was charged with 997 g. (6.0 mole) of isophthalic acid, 1119 g. (14.7 mole) of propylene glycol, and 637 g. (6.0 mole) of diethylene glycol.

Nitrogen flow rate was 0.5 standard cubic feet per hour. The reaction mixture was heated to a temperature of 190° C. over a period of about 90 min., and then gradually increased to 204° C. under reflux. The progress of the esterification was monitored by acid number titration, and the water that formed as the esterification proceeded was removed from the mixture by distillation. After about 5 hours, at an acid number of 18.3 mg KOH/gm, the molten polymer was cooled to 93° C. and held overnight; the acid number of the resin was 16.3 mg KOH/gm the following morning.

Propylene glycol lost by distillation was determined by measurement of refractive index of the condensate; 8.4 grams of propylene glycol were added to the reactor. The resin mass was heated to 160° C., and 1177 grams (12.0 mole) of molten maleic anhydride were added to the reactor. The temperature of the reaction mixture was increased to 230° C. over about 2 hours and held for four hours while removing water by distillation, until an acid number of 16.8 mg KOH/g was reached. The hydroxyl number of the resin, calculated from the final acid number and the stoichiometric ratio of glycol/acid, was 102 mg KOH/gram.

The resin mass was cooled to a temperature of about 180° C., 0.52 grams of hydroquinone was added, and the hot polymer melt was poured into 1500 grams of styrene (styrene/maleic ratio=1.5) with good agitation and cooling to maintain the temperature of the styrene solution below about 80° C. The solution was then cooled to room temperature, filtered, and stored.

Additional unsaturated polyesters were prepared substantially according to the procedure for isopolyester, using phthalic anhydride and terephthalic acid in place of the isophthalic acid. A second isopolyester, employing neopentyl glycol in place of the propylene glycol and having a hydroxyl number of 42, an acid number of 16 and styrene/maleic ratio of 2.2, was also prepared by following substantially the same procedure. The quantity of cobalt octoate accelerator and methyl ethyl ketone peroxide required to provide a gel time of 45-60 minutes at room temperature was determined for each resin. The compositions of the four resins are summarized in the following Table I, together with the amounts of peroxide and accelerator.

TABLE I

| Resin: | A | B | C | D |
|---|---|---|---|---|
| Isophthalic acid (m) | 1.0 | — | — | 1.0 |
| Phthalic anhydride (m) | — | 1.0 | | — |
| Terephthalic acid (m) | — | — | 1.0 | — |
| Maleic anhydride (m) | 2.0 | 2.0 | 2.0 | 1.0 |
| Propylene glycol (m) | 2.45 | 2.45 | 2.45 | |
| Diethylene glycol (m) | 1.0 | 1.0 | 1.0 | 1.05 |
| Neopentyl glycol (m) | — | — | — | 1.05 |
| non-volatiles (wt %) | 60 | 60 | 60 | 65 |
| CoOct (wt %) | 0.15 | 0.15 | 0.15 | 0.3 |
| MEKP (wt %) | 0.6 | 0.6 | 0.6 | 0.6 |

Composites

Generally described, the unsaturated polyester, diisocyanate, cobalt octoate and methyl ethyl ketone peroxide were weighed into a resin bath and mixed. Carbon fiber tapes were wetted in the resin bath and placed in a stainless steel mold having a trough with dimensions 0.375 inch×6 inches, and compressed to a thickness of about 0.125 inch using a stainless steel beam supported by 0.125 inch pins. The carbon content in the uncured specimen was about 45 volume percent. The mold containing the specimen was heated for one hour in oven held at an 80° C. The specimen was then removed from the mold and post-cured for two hours at 100° C., to provide a uniaxial carbon fiber-reinforced beam having nominal dimensions of 0.125×0.375×6 inches.

### Examples 1-3

Composite specimens were prepared as described above from CF-1 carbon fiber 48K tow with matrix resin formulations comprising unsaturated polyester resins A, B and C, modified by the addition of 6.82 grams of isophorone diisocyanate (IPDI) to 150 grams of resin (NCO:OH ratio=0.375).

### Comparison Examples C-1 through C-3

For comparison purposes, composite specimens were prepared as described above using 48K tow carbon fibers and unmodified unsaturated polyesters A, B and C.

Mechanical properties of composite specimens made with modified polyesters are presented in the following Table II, together with the mechanical properties for the corresponding comparison examples.

TABLE II

| Ex. | | Flex Mod | Flex Str | Shear Str |
|---|---|---|---|---|
| No. | Resin | (Msi) | (Ksi) | (Ksi) |
| 1 | A | 15.7 | 236 | 12.3 |
| C-1 | A | 15.8 | 239 | 8.9 |
| 2 | B | 15.8 | 259 | 12.1 |
| C-2 | B | 15.9 | 237 | 8.2 |
| 3 | C | 16.3 | 244 | 11.7 |
| C-3 | C | 15.9 | 243 | 9.1 |

It will be apparent from a comparison of mechanical properties for the composites made with polyester modified with isocyanate with those of the corresponding comparison examples made with unmodified polyester resin that adding isocyanate produced a dramatic, unexpected and unpredictable increase in short beam shear strength, without loss of flexural properties. Short beam shear strength is a measure of the adhesion between fiber and matrix resin; flexural modulus is related to fiber properties, and is less dependent on matrix resin properties.

Pot life of IPDI-modified Resin A was determined by preparing a composition equivalent to the matrix resin formulation of Example 1 and allowing the mixture to age before forming composite test specimens with carbon fiber, substantially as described above. Free IPDI, determined by GPC, was found to be slowly consumed after mixing with the isopolyester resin; the IPDI was fully reacted with the polyester after about one day.

Carbon fiber composites were made as described above, using IPDI modified resin aged for various periods before combining with MEKP and cobalt octoate. The resin properties and mechanical properties of the composites are summarized in the following Table III.

TABLE III

| Time | Brookfield | Mw | | Flex Str | Shear Str |
|---|---|---|---|---|---|
| hr. | Visc., cps | g/mole | Mw/Mn | Ksi | Ksi |
| 0.5 | 330 | 3174 | 2.1 | 236 | 12.3 |
| 6 | 260 | 3029 | 2.1 | 223 | 11.3 |
| 24 | 710 | 3783 | 2.0 | 264 | 10.9 |
| 96 | 950 | 4602 | 2.0 | 194 | 8.7 |

It will be apparent from a consideration of the viscosity and molecular weight data presented in Table III that, as the modified resin aged, little change in resin molecular weight occurred during the first few hours, and the change that occurred even after 24 hours was not large. Resin viscosity increased from 330 cps to 710 cps in that same period. However, over the period of about four days, the shear strength was reduced to the strength of composites made with unmodified resin. The useful pot life of IPDI-modified resin A, after mixing, thus appears to be about 24-48 hours.

Pot life of a resin formulation will vary with the particular polyester, with the diisocyanate employed in the formulation, and with the level of isocyanate. Resin A modified with Isonate 143L, an oligomeric MDI aromatic isocyanate (NCO:OH=0.375), had a pot life of less than 24 hours. At 24 hours after mixing, the viscosity of the resin formulation had an unacceptable increase, to 6700 cps. The short beam shear strength of a test composite made with the aged resin had fallen to that of the unmodified resin.

An unsaturated polyester resin in styrene having a hydroxyl number of 34 and an acid number of 16, modified with IPDI (NCO:OH=0.50), had an initial viscosity of 675 cps, a viscosity of 890 cps after 2 hours, and an unacceptably high viscosity of 1305 cps after 5 hours. A composite made substantially as described from the initial composition using Fortafil 511 carbon fiber had a short beam shear strength of 11.6 Ksi. A composite made from the composition aged for 5 hours, using Fortafil 511 carbon fiber, had a short beam shear strength of 11.0 Ksi. A control composite had a short beam shear strength of 6.7 Ksi. At 24 hours after mixing, the viscosity of the resin formulation had increased to 4990 cps; the short beam shear strength of a test composite made with the aged resin had fallen to 8.8 cps.

### Examples 4-9 and Comparison Example C-4

Seven composite test specimens were formed by the method of Examples 1-3, using CF-2 carbon fiber. The quantity of IDPI was 0 to 62.5 percent relative to the total number of hydroxyl groups available in the unsaturated polyester resin (NCO:OH=0 to 0.625).

TABLE IV

| | | |
|---|---|---|
| Ex. | IDPI | Shear Str |

| No. | g | NCO:OH | Ksi |
|---|---|---|---|
| C-4 | 0 | 0 | 9.4 |
| 4 | 0.91 | 0.05 | 10.4 |
| 5 | 2.27 | 0.13 | 10.6 |
| 6 | 4.55 | 0.25 | 10.7 |
| 7 | 6.82 | 0.38 | 12.1 |
| 8 | 9.1 | 0.50 | 12.3 |
| 9 | 11.37 | 0.625 | 12.2 |

It will be seen that the improvement in adhesion between fiber and resin increases with increased amounts of isocyanate, up to an NCO:OH ratio of 0.38. Further increases in isocyanate content provided little further property improvement. Moreover, at the higher isocyanate levels, upon reaction with the polyester, an increase viscosity will be observed. Ratios greater than about 0.625 will not be preferred.

### Comparison Examples C-5-C-8

Four composites were prepared as described above using isocyanate-modified unsaturated isopolyester resin A dissolved in styrene at 60% NVM as the matrix resin component, with four different commercial carbon fibers. The matrix resin component was modified with IDPI (6.82 grams of IDPI per 150 grams of unsaturated polyester resin A; NCO:OH=0.375).

For comparison purposes, four additional composites were prepared, using substantially the same procedures, from the same commercial carbon fibers and unmodified resin A.

The short beam shear strengths of the invented composites and the corresponding comparison examples are summarized in the following Table V.

TABLE V

| Ex. | Carbon | Shear Str |
|---|---|---|
| No. | Fiber | Ksi |
| 10 | CF-3 | 12.1 |
| C-5 | CF-3 | 9.4 |
| 11 | CF-4 | 11.1 |
| C-6 | CF-4 | 8.8 |
| 12 | CF-5 | 10.5 |
| C-7 | CF-5 | 7.8 |
| 13 | CF-6 | 12.5 |
| C-8 | CF-6 | 8.9 |

As the data in Table V illustrate, short beam shear strength for each of the different carbon fiber-reinforced composites was dramatically and unpredictably increased for all composites according to the invention.

### Examples 14-18 and Comparison Example C-9

Test specimens of five composites were prepared substantially as described above using CF-2 carbon fiber tow and unsaturated polyester resin A modified with different diisocyanates (NCO:OH=0.375) as the matrix resin component.

For comparison purposes, an additional composite was prepared, using substantially the same procedures, from the same carbon fiber with unmodified resin A. The compositions and mechanical properties of the composites are summarized in the following Table VI.

TABLE VI

| Ex. | | Flex Mod | Flex Str | Shear Str |
|---|---|---|---|---|
| No. | diisocyanate | Msi | Ksi | Ksi |
| C-9 | none | 16.6 | 216 | 9.3 |
| 14 | IPDI | 16.9 | 236 | 12.1 |
| 15 | HMDI | 16.8 | 233 | 11.6 |
| 16 | MDI | 17.5 | 234 | 11.6 |
| 17 | TDI | 16.5 | 229 | 12.1 |
| 18 | Isonate | 16.6 | 228 | 11.8 |

It will be apparent that the shear strength of the invented composites is significantly improved whether using an aliphatic diisocyanate as in Examples 14 and 15, or an aromatic diisocyanate as in Examples 16-18. As noted above, resin formulations comprising aliphatic diisocyanates generally will have a longer pot life; thus aliphatic diisocyanates will be preferred.

### Example 19 and Comparison Example C-10

A carbon fiber composite was prepared substantially as described above using CF-2 carbon fiber tow and unsaturated polyester resin A modified with IPDI (NCO:OH=0.375). For comparison purposes, an additional composite was prepared, using substantially the same procedures, from the same carbon fiber with unmodified resin A.

Test specimens were immersed in boiling water for 100 hours, and then tested for Short Beam Shear strength. The initial shear strength and shear strength after boiling water immersion are presented in the following Table VII.

TABLE VII

| | Shear Strength | | |
|---|---|---|---|
| | | 100 hr. in | |
| Ex. | initial | boiling H₂O | Retained |
| No. | Ksi | Ksi | % |
| 19 | 12.1 | 9.8 | 82 |
| C-10 | 9.3 | 4.5 | 48 |

### Examples 20 and Comparison Example C-11

Composite specimens were prepared as described above from CF-3 carbon fiber 12K tow and a matrix resin formulation comprising unsaturated polyester resin D, modified by the addition of 6.82 grams of isophorone diisocyanate (IPDI) to 150 grams of resin. For comparison purposes, composite specimens were also prepared with the same carbon fiber and the unmodified polyester resin D.

The invented composite, Example 20, had a flex modulus of 16.8 Msi, a flex strength of 216 Ksi, and a short beam shear strength of 10.7 Ksi. The comparison composite made without IPDI, Example C-11, had a flex modulus of 16.5 Msi, a flex strength of 227 Ksi, and a short beam shear strength of 8.9 Ksi.

The invention will thus be understood to be directed to modified unsaturated polyester matrix resin compositions with good adhesion to carbon fiber. The invented polyester resins comprise an unsaturated polyester dissolved or dispersed in a copolymerizable liquid monomer together with an organic polyisocyanate. More particularly described, the matrix resin composition will comprise the product of the polyesterification of a mixture comprising a di- or polycarboxylic acid or an ester or anhydride thereof, preferably a phthalic acid, more preferably isophthalic acid; an unsaturated carboxylic acid, or an alkyl ester or anhydride thereof, preferably maleic anhydride, and at least one di-or polyhydric alcohol, preferably selected from ethylene glycol, propylene glycol and neopentyl glycol, said polyester having a hydroxyl number in the range of from about 30 to about 120 mg KOH/g of polyester; a liquid monomer, preferably a vinylaromatic monomer, more preferably styrene, copolymerizable with said product; and an organic polyisocyanate, preferably a diisocyanate selected from aromatic diisocyanates and aliphatic diisocyanates, the molar ratio of the isocyanate groups of said polyisocyanate to the hydroxyl groups of said unsaturated polyester in said composition lying in the range of from about 0.05 to about 0.65, preferably from about 0.35 to about 0.50.

Matrix resin formulations comprising isophorone diisocyanate and an unsaturated isophthalate polyester dissolved in styrene monomer are particularly preferred. Compositions according to the invention may further comprise curing agents and initiators, and may be thermally cured.

The invented matrix resins exhibit improved adhesion to carbon fiber, as reflected in increased short beam shear strength properties. The modified resins are particularly suited for the production of carbon fiber-reinforced plastics including composites; hence, the invention may be further characterized as directed to filled compositions comprising from about 35 to about 60 volume percent carbon fiber and a modified unsaturated polyester matrix resin, and to carbon fiber-reinforced composites resulting from curing such compositions. The invented composites exhibit enhanced adhesion between the resin and the carbon fiber, as demonstrated by increased short beam shear strength.

While the invention has been illustrated by means of specific embodiments, these are not intended to be limiting. Further additions and modifications will be readily apparent to those skilled in the art, and such modifications and additions, and compositions, formulations and articles embodying them, are contemplated to lie within the scope of the invention as defined and set forth in the following claims.

We claim:

1. A composition comprising an unsaturated polyester, a polyisocyanate, and a copolymerizable liquid ethylenically unsaturated monomer, the molar ratio of the isocyanate groups to the hydroxyl groups in said composition lying in the range of from about 0.05 to about 0.65.

2. The composition of claim 1 wherein said unsaturated polyester has a reactive hydroxyl group content represented by a hydroxyl number of from about 30 to about 120 mg KOH/g of resin.

3. The composition of claim 1 wherein said monomer is a vinylaromatic monomer.

4. The composition of claim 1 wherein said monomer is styrene.

5. The composition of claim 1 wherein said polyisocyanate is selected from the group consisting of aromatic diisocyanates and aliphatic diisocyanates.

6. The composition of claim 1 wherein said polyisocyanate is selected from the group consisting of isophorone diisocyanate, hexamethylene diisocyanate, methylene diphenyl diisocyanate, toluene diisocyanate, and oligomeric methylene diphenyl diisocyanate.

7. A composition comprising an unsaturated polyester having a reactive hydroxyl group content represented by a hydroxyl number of from about 30 to about 120 mg KOH/g of resin; a polyisocyanate selected from the group consisting of aromatic diisocyanates and aliphatic diisocyanates; and a copolymerizable liquid monomer, the molar ratio of the isocyanate groups to the hydroxyl groups in said composition lying in the range of from about 0.05 to about 0.65.

8. The composition of claim 7 wherein said unsaturated polyester is the product of the polyesterification of an aromatic dicarboxylic acid, an ethylenically unsaturated dicarboxylic acid, and at least one polyhydric alcohol.

9. The composition of claim 7 wherein said unsaturated polyester is the product of the polyesterification of an aromatic dicarboxylic acid selected from the group consisting of isophthalic acid, orthophthalic acid, terephthalic acid and esters and anhydrides thereof; an unsaturated carboxylic acid selected from the group consisting of maleic acid, fumaric acid, citaconic acid, chloromaleic acid, allyl succinic acid, itaconic acid, mesaconic acid and alkyl esters and anhydrides thereof; and at least one polyhydric alcohol selected from the group consisting of neopentyl glycol, ethylene glycol, diethylene glycol, triethylene glycol, propylene glycol, dipropylene glycol, 1,4-butanediol, polyethylene glycol, mannitol, 1,2-propanediol, 1,6-hexanediol, and 1,3-butylene glycol.

10. The composition of claim 7 wherein said polyisocyanate is selected from the group consisting of isophorone diisocyanate, hexamethylene diisocyanate, methylene diphenyl diisocyanate, toluene diisocyanate, and oligomeric methylene diphenyl diisocyanate.

11. The composition of claim 7 further comprising a polymerization catalyst.

12. A fiber-reinforced composite comprising from about 35 to about 60 volume percent carbon fibers, based upon the total volume of the composite, imbedded in the resin reaction product of a mixture comprising:
from about 30 to about 50 parts by weight of ethylenically unsaturated liquid monomer;
from about 70 to about 50 parts by weight of an unsaturated polyester having a reactive hydroxyl group content represented by a hydroxyl number of from about 30 to about 120 mg KOH/g of resin; and
an amount of an organic polyisocyanate sufficient to provide from about 0.05 to about 0.65 moles of isocyanate groups per mole of said reactive hydroxyl groups.

13. The fiber reinforced composite according to claim 12 further comprising a polymerization catalyst.

14. The fiber-reinforced composite according to claim 12 wherein said monomer is a vinylaromatic monomer.

15. The fiber-reinforced composite according to claim 12 wherein said polyester is the product of the polyesterification of an aromatic dicarboxylic acid, an ethylenically unsaturated dicarboxylic acid, and at least one polyhydric alcohol.

16. The fiber-reinforced composite according to claim 12 wherein said polyester is the product of the polyesterification of a dicarboxylic acid selected from the group consisting of isophthalic acid, orthophthalic acid, terephthalic acid and esters and anhydrides thereof; maleic acid, or anhydride; and at least one polyhydric alcohol selected from the group consisting of neopentyl glycol, ethylene glycol, diethylene glycol, and propylene glycol.

17. A method for making a carbon fiber-reinforced plastic comprising the step of impregnating continuous carbon fibers with a resin composition comprising an unsaturated polyester having a hydroxyl value of from about 30 to about 120, a copolymerizable liquid monomer and an amount of an organic polyisocyanate sufficient to provide from about 0.05 to about 0.65 moles of isocyanate groups per mole of said reactive hydroxyl groups, thereby providing impregnated carbon fiber prepreg containing from about 35 to about 60 volume percent carbon fiber.

18. The method of claim 17 further comprising the steps of molding and curing said prepreg.

19. The method of claim 17 wherein said polyester is the polyesterification product of an aromatic dicarboxylic acid selected from isophthalic acid, terephthalic acid and orthophthalic acid, or an ester or anhydride thereof; maleic anhydride, and at least one polyhydric alcohol.

20. The method of claim 17 wherein said organic polyisocyanate is selected from the group consisting of isophorone diisocyanate, hexamethylene diisocyanate, methylene diphenyl diisocyanate, toluene diisocyanate, and oligomeric methylene diphenyl diisocyanate.

21. In a composition comprising an unsaturated polyester having a reactive hydroxyl group content represented by a hydroxyl number of from about 30 to about 120 mg KOH/g of resin, a polyisocyanate, and a copolymerizable liquid monomer, the improvement wherein the molar ratio of the isocyanate groups to the hydroxyl groups is in the range of from about 0.05 to about 0.65.
